(19) United States
(12) Patent Application Publication
(10) Pub. No.: US 2025/0330884 A1
(43) Pub. Date: Oct. 23, 2025

(54) SYSTEM AND METHOD FOR PROVIDING FIXED WIRELESS ACCESS TO USERS USING CELL RESELECTION

(71) Applicant: JIO PLATFORMS LIMITED, Ahmedabad (IN)

(72) Inventors: Ranjit Ma KUMAR, Jabalpur (IN); Kazim MARUF, Jabalpur (IN); Pappu KUMAR, Madhubani (IN); Dhananjay PATHAK, Faizabad (IN); Sonender KUMAR, Etawah (IN); Pravin Sahebrao UBALE, Buldana (IN)

(73) Assignee: JIO PLATFORMS LIMITED, Ahmedabad (IN)

(21) Appl. No.: 19/184,325

(22) Filed: Apr. 21, 2025

(30) Foreign Application Priority Data
Apr. 19, 2024 (IN) 202421031458

(51) Int. Cl. H04W 36/00; H04B 17/318; H04W 24/10

(52) U.S. Cl. CPC H04W 36/0079; H04B 17/328; H04W 24/10

(57) ABSTRACT

The present disclosure provides a system (112) and a method for providing fixed wireless access to users using reselection. The system (112) determines a Radio Link Failure (RLF) condition associated with a Fixed Wireless Access (FWA) device (102). The RLF condition indicates a loss of connection of the FWA device (102) with a primary base station (104) among one or more base stations in a Radio Access Network (RAN) (108). The system (112) receives a measurement report from the FWA device (102) comprising a Reference Signal Received Power (RSRP) associated with the one or more base stations. The system (112) transmits a measurement event to the FWA device (102). The system (112) facilitates the FWA device (102) to connect to an optimum base station in the RAN (108) among the one or more base stations when the RSRP of the optimum base station is at a threshold.

### RESERVATION OF RIGHTS

A portion of the disclosure of this patent document contains material, which is subject to intellectual property rights such as but are not limited to, copyright, design, trademark, integrated circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF INVENTION

The embodiments of the present disclosure relate to a field of wireless networks. More particularly, the present disclosure relates to a system and a method for providing Fixed Wireless Access (FWA) to users using cell reselection.

### BACKGROUND

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

Fixed Wireless Access (FWA) devices are required to camp on the best and the nearest cell to provide optimal network experiences to users accessing internet/streaming/gaming and various other internet services. To avoid frequent handovers between multiple cells that would result in degradation of end-user experiences, necessary optimizations are used to force the device stay on the best available cell. In situations where the best camped cell goes down due to multiple reasons, the device will get camped on a far cell which may not be an ideal cell to camp on to provide the best experience. Now, when the best or the near cell comes up, and since optimizations to avoid handovers are in place, the device will stay camped to the far cell until the device goes to Radio Resource Control (RRC) idle state or performs a fresh selection of cell post reboot. Since these devices have multiple users/clients accessing internet and further include multiple embedded applications, the devices are very unlikely to release the RRC connection and perform a reselection of the best cell. This will impact the end user until the device is configured as per requirements.

There is, therefore, a need in the art to provide a system and a method that can mitigate the problems associated with conventional systems and facilitate FWA devices to select and stay on a best available cell.

### OBJECTS OF THE INVENTION

Some of the objects of the present disclosure, which at least one embodiment herein satisfies are listed herein below.

It is an object of the present disclosure to provide a system and a method for providing fixed wireless access to users using cell reselection in a Radio Access Node (RAN).

It is an object of the present disclosure to provide a system that determines a radio condition of a user equipment (UE)/Fixed Wireless Access (FWA) device based on a Reference Signal Received Power (RSRP) received from the one or more base stations in the RAN.

It is an object of the present disclosure to provide a system that transmits a measurement event to the FWA device to facilitate RRC re-establishment of the FWA device in the RAN when the RSRP of the one or more base stations exceeds a threshold.

It is an object of the present disclosure to provide a system that facilitates Radio Resource Control (RRC) re-establishment of the FWA device based on the measurement event.

### SUMMARY

This section is provided to introduce certain objects and aspects of the present disclosure in a simplified form that are further described below in the detailed description. This summary is not intended to identify the key features or the scope of the claimed subject matter.

In an aspect, the present disclosure relates to a system for providing wireless communication access. The system includes a processor operatively coupled to a Radio Access Network (RAN). The RAN is communicatively coupled to a core network for connecting one or more users to the core network. A memory is operatively coupled with the processor, where said memory stores instructions which, when executed by the processor, causes the processor to determine a Radio Link Failure (RLF) condition associated with a Fixed Wireless Access (FWA) device. The RLF message indicates a loss of connection of the FWA device with a primary base station among one or more base stations in the RAN. The processor receives a measurement report from the FWA device including a Reference Signal Received Power (RSRP) associated with the one or more base stations. The processor transmits a measurement event to the FWA device. The processor facilitates the FWA device to connect to an optimum base station among the one or more base stations in the RAN when the RSRP of the optimum base station is at a threshold.

In an embodiment, the processor may transmit an A3 event associated with the measurement event to the FWA device.

In an embodiment, the FWA device may connect to a secondary base station among the one or more base stations upon the loss of connection with the primary base station.

In an embodiment, the A3 measurement may include a configurable offset and a measurement identification (ID).

In an embodiment, the processor may transmit a RRC release message to the FWA device upon receiving the measurement report from the FWA device for the A3 event for releasing the connection with the secondary base station.

In an aspect, the present disclosure relates to a method for providing wireless communication access. The method includes determining, by a processor, associated with a system, a RLF condition from an FWA device. The RLF condition indicates a loss of connection of the FWA device with a primary base station among one or more base stations in a RAN. The method includes receiving, by the processor, a measurement report from the FWA device including a RSRP associated with the one or more base stations. The method includes transmitting, by the processor, a measurement event to the FWA device. The method includes facilitating, by the processor, the FWA device to connect to an optimum base station among the base stations in the RAN when the RSRP of the optimum base station is at a threshold.

In an embodiment, the method may include transmitting, by the processor, an A3 event associated with the measurement event to the FWA device.

In an embodiment, the A3 measurement may include a configurable offset and a measurement identification (ID).

In an embodiment, the FWA device may connect to a secondary base station among the one or more base stations upon the loss of connection with the primary base station.

In an embodiment, the method may include transmitting, by the processor, a Radio Resource Control (RRC) release message to the FWA device upon receiving the measurement report from the FWA device for the A3 event.

In an aspect, a UE for sending information includes one or more processors communicatively coupled to a processor associated with a system. The one or more processors are coupled with a memory, where said memory stores instructions, which when executed by the one or more processors, cause the one or more processors to transmit a RLF condition to the processor. The RLF condition indicates a loss of connection of the UE with a primary base station among one or more base stations in a RAN. The one or more processors are configured to send a measurement report to the processor including a RSRP associated with the one or more base stations. The one or more processors are configured to receive a measurement event from the processor. The one or more processors are configured to facilitate a connection of the UE to an optimum base station among the one or more base stations in the RAN when the RSRP of the optimum base station is at a threshold.

### BRIEF DESCRIPTION OF DRAWINGS

The accompanying drawings, which are incorporated herein, and constitute a part of this disclosure, illustrate exemplary embodiments of the disclosed methods and systems which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components, or circuitry commonly used to implement such components.

FIG. 1 illustrates an example flow diagram (100) representing wireless communication using Fixed Wireless Access (FWA) devices in a core network, in accordance with an embodiment of the present disclosure.

FIG. 2 illustrates an example block diagram (200) of a proposed system (112), in accordance with an embodiment of the present disclosure.

FIG. 3 illustrates an example flow diagram (300) of cell reselection through RRC connection re-establishment, in accordance with an embodiment of the present disclosure.

FIG. 4 illustrates an example computer system (400) in which or with which embodiments of the present disclosure may be implemented.

The foregoing shall be more apparent from the following more detailed description of the disclosure.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail to avoid obscuring the embodiments.

Also, it is noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive in a manner similar to the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the disclosure. As used herein, the singular forms “a”, “an”, and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

The present disclosure describes reselection of cells by Fixed Wireless Access (FWA) devices for providing quality wireless internet services to user equipments (UE's) connected to the FWA devices. Reselection of cells is based on recommendations provided by a Radio Access Node (RAN) connected to the FWA devices. A separate measurement event with required an extended offset value is configured by the RAN. The RAN may respond on the measurement reports received from the UE's by abruptly releasing an established Radio Resource Control (RRC) connection with a pre-existing cell/base station. This will enable the UE's to go into a RRC idle state and allow reselection of a best available cell/an optimum cell for transmitting data.

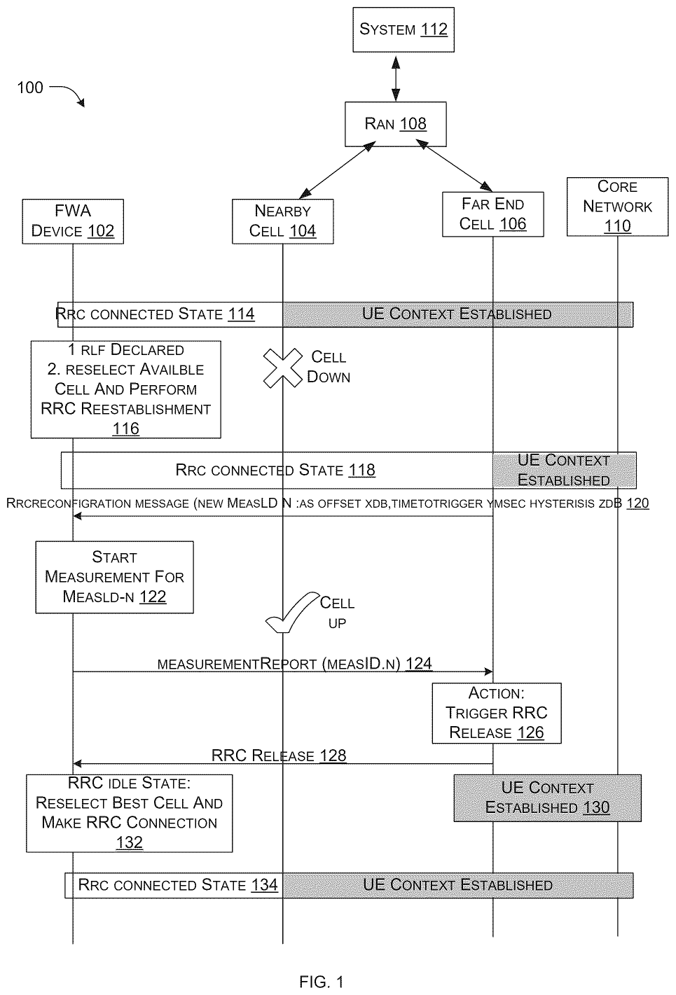

Various embodiments of the present disclosure will be explained in detail with reference to FIGS. 1-4.

FIG. 1 illustrates an example flow diagram (100) representing wireless communication using Fixed Wireless Access (FWA) devices in a core network, in accordance with an embodiment of the present disclosure.

As illustrated in FIG. 1, a Radio Access Node (RAN) (108) may interface with a core network (110) for providing one or more users access to wireless networks. Further, the RAN (108) may include a primary base station (104) and a secondary base station (106) among one or more base stations. A FWA device (102) may be connected to the RAN (108) for providing wireless network services from the core network (110). A person skilled in the art may understand that the primary base station (104) may be referred as a nearby cell and the secondary base station (106) may be referred as a far end cell in the RAN (108). Further, the RAN (108) may be communicatively coupled with a system (112) throughout the disclosure. Further, the FWA device (102) may also include user equipments (UE's) connected to the RAN (108) for allowing the one or more users access to the wireless networks.

In an embodiment, the system (112) may enable the FWA device (102) to stay and reselect on the best available near cell/optimum cell in the RAN (108) to maintain the best quality of internet services. For example, the FWA device (102) may get stuck on the far end cell due to existing optimizations to avoid frequent handovers, affecting the quality of internet services offered to the one or more users. Therefore, the system (112) may transmit a separate measurement event with required extended offset value for reconnecting to a best available cell in the RAN (108). The RAN (108) may receive the measurement reports from the FWA device (102) and facilitate a release of the established RRC connection with the far end cell. This may enable the FWA device (102) to go into RRC idle state and allow the FWA device (102) to reselect the best available cell again.

In an embodiment, cell reselection may be an idle mode feature associated with the FWA device (102). If the FWA device (102) finds a better cell than the currently cell, the FWA device (102) may trigger reselection. However, handovers/connections to other base stations (for example, the primary base station (104) or the secondary base station (106)) may be initiated by the RAN (108) in a connected mode.

In an embodiment, the FWA device (102) may be installed in a fixed location such as but not limited to a residential house, an apartment building, or an office building.

In an embodiment, the system (112) may receive a Radio Link Failure (RLF) condition from a Fixed Wireless Device (FWA) (102). The RLF condition indicates a loss of connection of the FWA device (102) with a primary base station (104) among the one or more base stations in the RAN (108). The system (112) may receive a measurement report from the FWA device (102) comprising a Reference Signal Received Power (RSRP) associated with the one or more base stations.

In an embodiment, the system (112) may transmit a measurement event to the FWA device (102). The system (112) may facilitate the FWA device (102) to connect to an optimum base station among the one or more base stations in the RAN (108) when the RSRP of the optimum base station is at a threshold. Further, the system (112) may transmit a RRC release message to the FWA device (102) upon receiving the measurement report from the FWA device (102) for the A3 event for releasing the connection with the secondary base station (106).

In an embodiment, the system (112) may transmit an A3 event associated with the measurement event to the FWA device (102). The A3 event may include a configurable offset and a measurement identification (ID). The A3 event may be transmitted to FWA device (102) without checking any conditions. The A3 event may be configured once FWA device (102) moves to the secondary base station (106) so that the FWA device (102) can again start measuring signals from the neighbouring cells to identify whether the primary base station (104) is active at the current moment or not.

For example, in an embodiment, the A3 event may be triggered when the neighbor cell becomes better than the current cell by an offset. Event A3 may be triggered when the RSRP of a neighbor cell is stronger than the RSRP of the current cell.

In an embodiment, the flow diagram (100) may include the following steps.

At step 114: The FWA device (102) may transmit a RRC Connection Request message to the system (112) based on a connected cell/primary base station (104) in the RAN (108).

At step 116: Based on malfunctioning of a primary base station (104), the FWA device (102) may request for RRC re-establishment in the RAN (108).

At step 118: The system (112) may enable connection to the secondary base station (106) in the RAN (108) upon determining that the primary base station (104) becoming inactive. A RRC reconfiguration message may be sent by the RAN (108) to the FWA device (102).

At step 120: The far end cell (106) may transmit a RRC reconfiguration message to the FWA device (102).

At step 122: The FWA device (102) may start measurement based on a measurement ID provided by the RAN (108).

At step 124: A measurement report may be transmitted to the RAN (108) from the FWA device (102) when an optimum cell is detected in the RAN (108) with a RSRP at a threshold.

At step 126: The RAN (108) may trigger a RRC release message.

At step 128: Based on a message from the FWA device (102) that the primary base station (104) is functional, the RAN (108) may transmit the RRC release message to the FWA device (102) to release the connection associated with the secondary base station (106) in the RAN (108).

At step 130: The core network (110) may enable the UE context release based on the data transmission by the FWA device (102).

At step 132: The FWA device (102) may go to an RRC idle state facilitate connection to the optimum/best cell/base station in the RAN (108) with a new RRC connection.

At step 134: The RRC connected state may be established in the RAN (108) based on the FWA device (102) connecting to the optimum base station among the one or more base stations in the RAN (108).

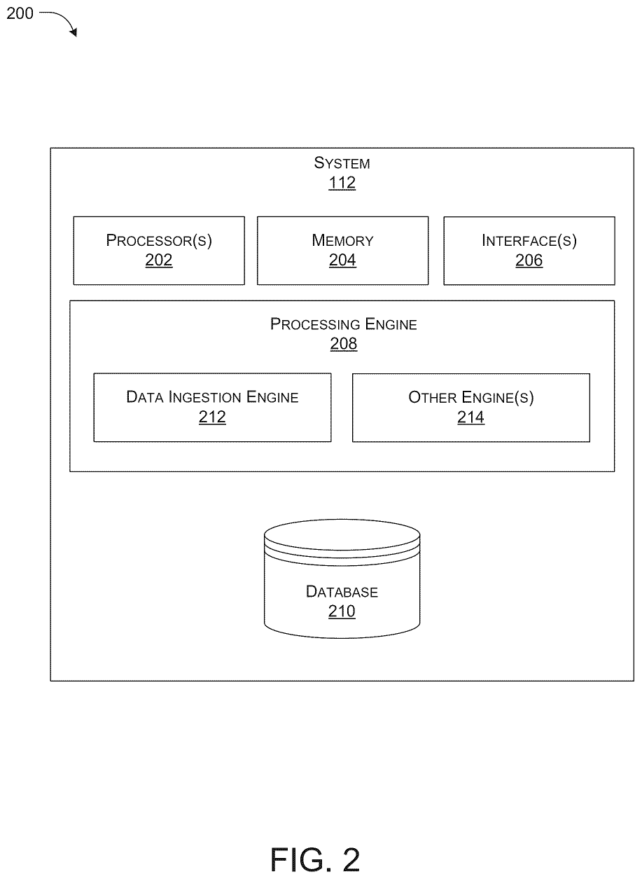

FIG. 2 illustrates an example block diagram (200) of a proposed system (106), in accordance with an embodiment of the present disclosure.

Referring to FIG. 2, the system (112) may comprise one or more processor(s) (202) that may be implemented as one or more microprocessors, microcomputers, microcontrollers, digital signal processors, central processing units, logic circuitries, and/or any devices that process data based on operational instructions. Among other capabilities, the one or more processor(s) (202) may be configured to fetch and execute computer-readable instructions stored in a memory (204) of the system (112). The memory (204) may be configured to store one or more computer-readable instructions or routines in a non-transitory computer readable storage medium, which may be fetched and executed to create or share data packets over a network service. The memory (204) may comprise any non-transitory storage device including, for example, volatile memory such as random-access memory (RAM), or non-volatile memory such as erasable programmable read only memory (EPROM), flash memory, and the like.

In an embodiment, the system (112) may include an interface(s) (206). The interface(s) (206) may comprise a variety of interfaces, for example, interfaces for data input and output (I/O) devices, storage devices, and the like. The interface(s) (206) may also provide a communication pathway for one or more components of the system (112). Examples of such components include, but are not limited to, processing engine(s) (208) and a database (210), where the processing engine(s) (208) may include, but not be limited to, a data ingestion engine (212) and other engine(s) (214). In an embodiment, the other engine(s) (214) may include, but not limited to, a data management engine, an input/output engine, or the like.

In an embodiment, the processing engine(s) (208) may be implemented as a combination of hardware and programming (for example, programmable instructions) to implement one or more functionalities of the processing engine(s) (208). In examples described herein, such combinations of hardware and programming may be implemented in several different ways. For example, the programming for the processing engine(s) (208) may be processor-executable instructions stored on a non-transitory machine-readable storage medium and the hardware for the processing engine(s) (208) may comprise a processing resource (for example, one or more processors), to execute such instructions. In the present examples, the machine-readable storage medium may store instructions that, when executed by the processing resource, implement the processing engine(s) (208). In such examples, the system (112) may comprise the machine-readable storage medium storing the instructions and the processing resource to execute the instructions, or the machine-readable storage medium may be separate but accessible to the system (112) and the processing resource. In other examples, the processing engine(s) (208) may be implemented by electronic circuitry.

In an embodiment, the processor (202) may receive a RLF condition via the data ingestion engine (212). The RLF condition may be received from a FWA (102). The processor (202) may store information associated with the RLF condition in the database (210). The RLF condition may indicate a loss of connection of the FWA device (102) with a primary base station (104) among one or more base stations in the RAN (108). The processor (202) may receive a measurement report from the FWA device (102) including a RSRP associated with the one or more base stations.

In an embodiment, the processor (202) may transmit a measurement event to the FWA device (102). The processor (202) may facilitate the FWA device (102) to connect to an optimum base station among the one or more base stations in the RAN (108) when the RSRP of the optimum base station is at a threshold. Further, the processor (202) may transmit a RRC release message to the FWA device (102). The processor (202) may transmit a measurement event to the FWA device (102). The processor (202) may facilitate the FWA device (102) to connect to an optimum base station in the RAN (108) among the one or more base stations when the RSRP of the optimum base station is at a threshold. The FWA device (102) may connect to a secondary base station (106) among the one or more base stations upon the loss of connection with the primary base station (104).

In an embodiment, the processor (202) may transmit an A3 event associated with the measurement event to the FWA device (102). The A3 event may include a configurable offset and a measurement identification (ID).

In an embodiment, the processor (202) may transmit a RRC release message to the FWA device (102) upon receiving the measurement report from the FWA device (102) for the A3 event.

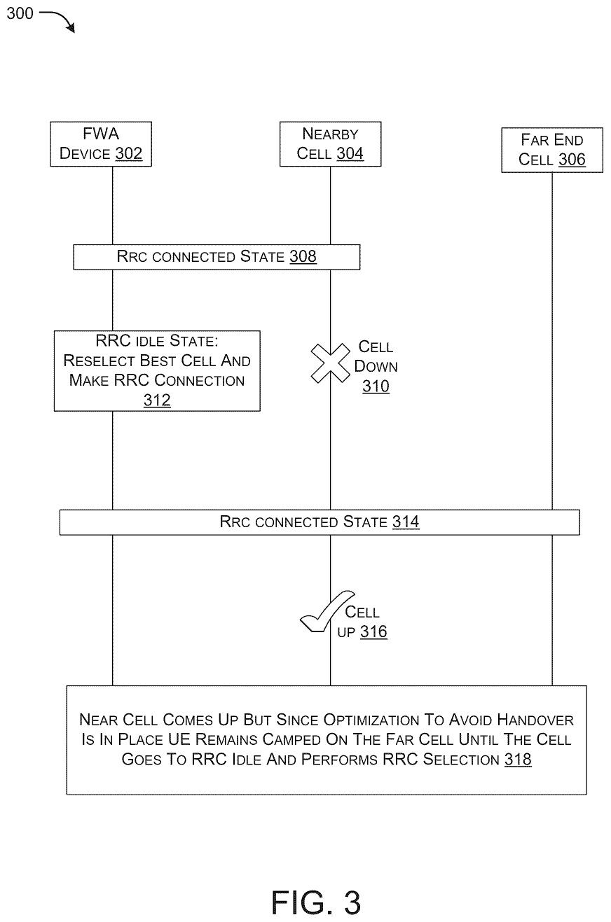

FIG. 3 illustrates an example flow diagram (300) of a cell reselection through RRC connection re-establishment, in accordance with an embodiment of the present disclosure.

In an embodiment, the flow diagram (300) may include the following steps.

At step 308: The FWA device (302) may transmit an RRCConnectionRequest message to a nearby cell (304). The nearby cell may include a primary base station (104).

At step 310: The FWA device (302) may detect that the nearby cell is down.

At step 312: The FWA device (302) may go to an idle state based on the state of the nearby cell. The FWA device (302) may facilitate one more connections with one or more base stations in the RAN and enable an RRC connection.

At step 314: The FWA device (302) may transmit the RRCConnectionRequest message to a far end cell (306). The far end cell (306) may include the secondary base station among the one or more base stations.

At step 316: The nearby cell may come up or be active again.

At step 318: However, as optimizations may be utilized to prevent handovers, the UE may still be camped or connected to the far end cell until the UE goes into a RRC idle state or performs RRC selection.

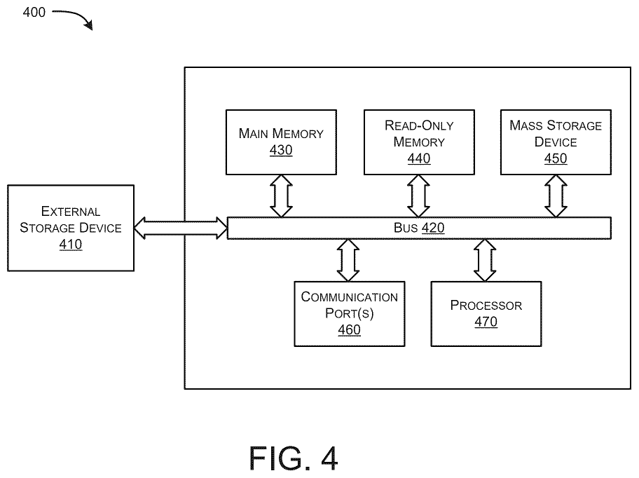

FIG. 4 illustrates an exemplary computer system (400) in which or with which embodiments of the present disclosure may be implemented.

As shown in FIG. 4, the computer system (400) may include an external storage device (410), a bus (420), a main memory (430), a read-only memory (440), a mass storage device (450), a communication port(s) (460), and a processor (470). A person skilled in the art will appreciate that the computer system (400) may include more than one processor and communication ports. The processor (470) may include various modules associated with embodiments of the present disclosure. The communication port(s) (460) may be any of an RS-232 port for use with a modem-based dialup connection, a 10/100 Ethernet port, a Gigabit or 10 Gigabit port using copper or fiber, a serial port, a parallel port, or other existing or future ports. The communication ports(s) (460) may be chosen depending on a network, such as a Local Area Network (LAN), Wide Area Network (WAN), or any network to which the computer system (400) connects.

In an embodiment, the main memory (430) may be Random Access Memory (RAM), or any other dynamic storage device commonly known in the art. The read-only memory (440) may be any static storage device(s) e.g., but not limited to, a Programmable Read Only Memory (PROM) chip for storing static information e.g., start-up or basic input/output system (BIOS) instructions for the processor (470). The mass storage device (450) may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces).

In an embodiment, the bus (420) may communicatively couple the processor(s) (470) with the other memory, storage, and communication blocks. The bus (420) may be, e.g. a Peripheral Component Interconnect PCI)/PCI Extended (PCI-X) bus, Small Computer System Interface (SCSI), USB, or the like, for connecting expansion cards, drives, and other subsystems as well as other buses, such a front side bus (FSB), which connects the processor (470) to the computer system (400).

In another embodiment, operator and administrative interfaces, e.g., a display, keyboard, and cursor control device may also be coupled to the bus (420) to support direct operator interaction with the computer system (400). Other operator and administrative interfaces can be provided through network connections connected through the communication port(s) (460). Components described above are meant only to exemplify various possibilities. In no way should the aforementioned exemplary computer system (400) limit the scope of the present disclosure.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter is to be implemented merely as illustrative of the disclosure and not as a limitation.

### Advantages of the Invention

The present disclosure enables Fixed Wireless Access (FWA) device users to have seamless, uninterrupted data connectivity by avoiding frequent handovers between cells.

The present disclosure allows the FWA device to remain camped to the best available cell which may include a nearby cell/primary base station.

The present disclosure allows the FWA device to reselect the best nearby cell by releasing its RRC connection with the far cell/secondary base station. The present disclosure provides a system that uses FWA devices to determine a radio condition of the serving and neighbor base stations based on a Reference Signal Received Power (RSRP) received from the serving and neighbor base stations via a Radio Access Network (RAN).

The present disclosure provides a system that facilitates Radio Resource Control (RRC) re-establishment of the FWA device based on a measurement event transmitted by the FWA device.

We claim:

1. A system (112) for providing wireless access, the system (112) comprising:
a processor (202) operatively coupled to a Radio Access Network (RAN) (108), wherein the RAN (108) is communicatively coupled to a core network (110) for connecting one or more users to the core network (110); and
a memory (204) operatively coupled to the processor (202), wherein said memory (204) stores instructions which, when executed by the processor (202), cause the processor (202) to:
determine a Radio Link Failure (RLF) condition associated with a Fixed Wireless Access (FWA) device (102), wherein the RLF condition indicates a loss of connection of the FWA device (102) with a primary base station (104) among one or more base stations in the RAN (108);
receive a measurement report from the FWA device (102) comprising a Reference Signal Received Power (RSRP) associated with the one or more base stations;
transmit a measurement event to the FWA device (102); and
facilitate the FWA device (102) to connect to an optimum base station in the RAN (108) among the one or more base stations when the RSRP of the optimum base station is at a threshold.

2. The system (112) as claimed in claim 1, wherein the processor (202) is to transmit an A3 event associated with the measurement event to the FWA device (102).

3. The system (112) as claimed in claim 1, wherein the FWA device (102) connects to a secondary base station (106) among the one or more base stations upon the loss of connection with the primary base station (104).

4. The system (112) as claimed in claim 2, wherein the A3 event comprises a configurable offset and a measurement identification (ID).

5. The system (112) as claimed in claim 2, wherein the processor (202) is to transmit a Radio Resource Control (RRC) release message to the FWA device (102) upon receiving the measurement report from the FWA device (102) for the A3 event.

6. A method for providing wireless access, the method comprising:
determining, by a processor (202), associated with a system (112), a Radio Link Failure (RLF) condition associated with a Fixed Wireless Access (FWA) device (102), wherein the RLF condition indicates a loss of connection of the FWA device (102) with a primary base station (104) among one or more base stations in a Radio Access Network (RAN) (108);
receiving, by the processor (202), a measurement report from the FWA device (102) comprising a Reference Signal Received Power (RSRP) associated with the one or more base stations;
transmitting, by the processor (202), a measurement event to the FWA device (102); and
facilitating, by the processor (202), the FWA device (102) to connect to an optimum base station among the one or more base stations in the RAN (108) when the RSRP of the optimum base station is at a threshold.

7. The method as claimed in claim 6, comprising transmitting, by the processor (202), an A3 event associated with the measurement event to the FWA device (102).

8. The method as claimed in claim 6, wherein the FWA device (102) connects to a secondary base station (106) among the one or more base stations upon the loss of connection with the primary base station (104).

9. The method as claimed in claim 7, wherein the A3 event comprises a configurable offset and a measurement identification (ID).

10. The method as claimed in claim 7, comprising transmitting, by the processor (202), a Radio Resource Control (RRC) release message to the FWA device (102) upon receiving the measurement report from the FWA device (102) for the A3 event.

11. A user equipment (UE) (102), comprising:
one or more processors communicatively coupled to a processor (202) associated with a system (112), wherein the one or more processors are coupled with a memory, and wherein said memory stores instructions, which when executed by the one or more processors, cause the one or more processors to:
transmit a Radio Link Failure (RLF) condition to the processor (202), wherein the RLF condition indicates a loss of connection of the UE (102) with a primary base station (104) among one or more base stations in a Radio Access Network (RAN) (108);
transmit a measurement report to the processor (202) comprising a Reference Signal Received Power (RSRP) associated with the one or more base stations;
receive a measurement event from the processor (202); and
facilitate a connection to an optimum base station among the one or more base stations in the RAN (108) when the RSRP of the optimum base station is at a threshold.
